(19) United States
(12) Patent Application Publication
(10) Pub. No.: US 2011/0051074 A1
(43) Pub. Date: Mar. 3, 2011

(54) INTERCHANGEABLE AND CUSTOMIZABLE EYEWEAR

(76) Inventor: Peter Arnell, Katonah, NY (US)

(21) Appl. No.: 12/871,647

(22) Filed: Aug. 30, 2010

Related U.S. Application Data
(60) Provisional application No. 61/238,507, filed on Aug. 31, 2009.

(51) Int. Cl. G02C 9/04; G02C 11/02; G02C 7/12; G02C 5/14

(52) U.S. Cl. 351/47; 351/52; 351/57; 351/116

(57) ABSTRACT

Viewing devices that are highly and easily customizable for a variety of viewing applications, such as for viewing three-dimensional images and movies, are provided. The viewing devices have interchangeable parts and lenses that can be easily changed out depending on the desired use. The interchangeable parts can be shaped or colored to suit a particular application, or which can be labeled with information such as marketing or branding logos. The parts can also be customized to fit a particular user.

### CROSS-REFERENCE TO RELATED APPLICATIONS

The present application claims the benefit of U.S. Provisional Patent Application No. 61/238,507, filed on Aug. 31, 2009.

### BACKGROUND OF THE DISCLOSURE

1. Field of the Disclosure

The present disclosure relates to viewing devices that can be modified, as desired, for use in a variety of applications. In particular, the present disclosure relates to viewing devices having a frame or subframe, which can be modified with attachments to suit a particular use or location.

2. Discussion of the Related Art

In the field of video imaging, the role of three-dimensional (3D) imaging, and the technology used to create it, are rapidly expanding and advancing. Currently available glasses and other devices used to view 3D images are very limited. They often comprise simple frames with viewing lenses that cannot be customized to a particular use or application. Different glasses would be needed for different applications or locations, such as in a movie theatre or for home use. In addition, currently available glasses do not have the ability to be customized to depict particular images, shapes, or marketing information that can be coordinated with the movie or other feature the viewer is watching. Accordingly, there is a need for a viewing device that can be customized to a particular application or use, which provides the user with a more enhanced viewing experience, while still maintaining low cost and ease of use.

### SUMMARY OF THE DISCLOSURE

The present disclosure provides viewing devices that are highly and easily customizable for a variety of viewing applications, such as for viewing three-dimensional images and movies. The viewing devices have interchangeable parts and lenses that can be easily changed out depending on the desired use, or which can be labeled with information such as marketing or branding logos. Thus, the viewing devices of the present disclosure provide a wide variety of possible applications, all while maintaining ease of use and low cost.

In one embodiment, the viewing device has a subframe that can have removable fronts, lenses, and temples for the sides. All of these components can be customized for a particular application. In another embodiment, the viewing device has a frame that can have lenses either permanently or removably connected thereto, and a visor that can be customized and placed over the frame.

The present disclosure also provides a viewing device for a user. The viewing device comprises a subframe having a front face, two side arms, and two lens openings, a front removably connected to the front face of the subframe, and two temples. Each of the two temples are removably connected to one of the side arms. The user wears the viewing device to look through the lens openings and the front, when the viewing device is in use.

### BRIEF DESCRIPTION OF THE DRAWINGS

FIG. 1 shows an exploded view of a first embodiment of the viewing device of the present disclosure;

FIG. 2 shows a second exploded view of the viewing device shown in FIG. 1;

FIG. 3 shows a perspective view of the viewing device of FIGS. 1 and 2, fully assembled;

FIG. 4 shows a second perspective view of the viewing device of FIGS. 1 and 2, fully assembled;

FIG. 5 shows a first perspective view of a first embodiment of the subframe of the viewing device of FIG. 1;

FIG. 6 shows a second perspective view of the subframe of FIG. 5;

FIG. 7 shows an exploded view of a second embodiment of the viewing device of the present disclosure;

FIG. 8 shows an exploded view of a third embodiment of the viewing device of the present disclosure;

FIG. 9 shows a perspective view of the viewing device shown in FIG. 8, fully assembled; and

FIG. 10 shows a perspective view of a frame used in the viewing device of FIG. 8.

### DETAILED DESCRIPTION OF THE DISCLOSURE

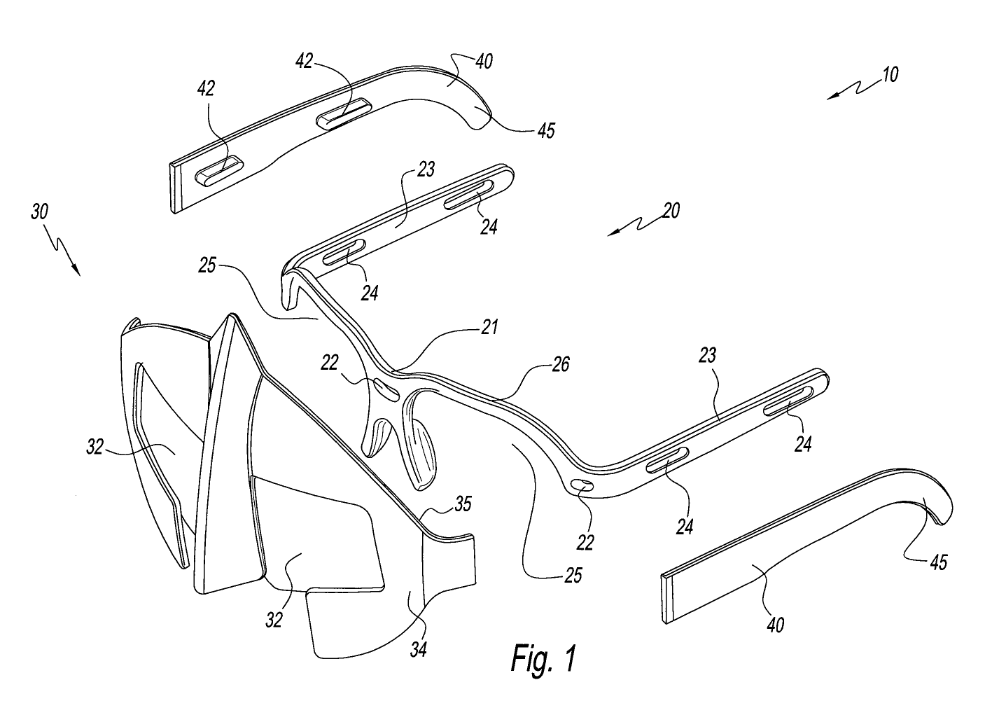

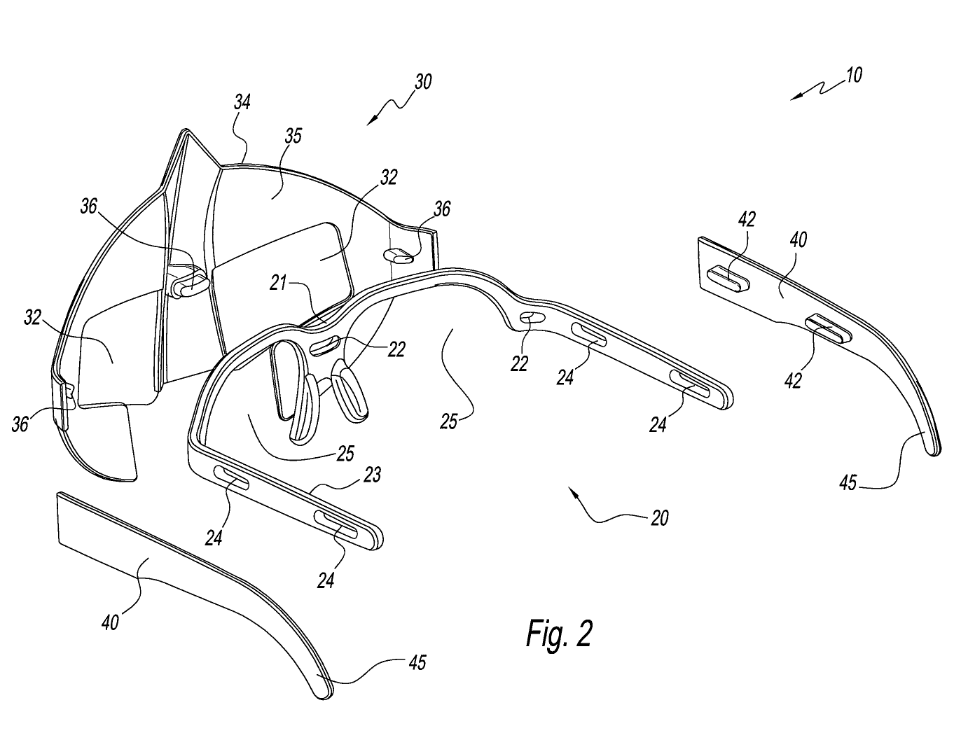

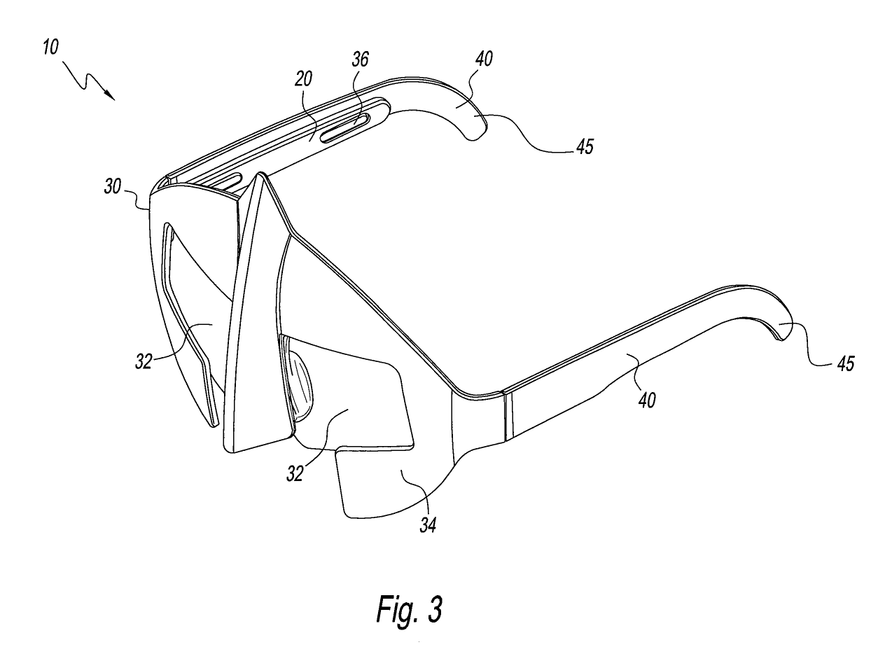

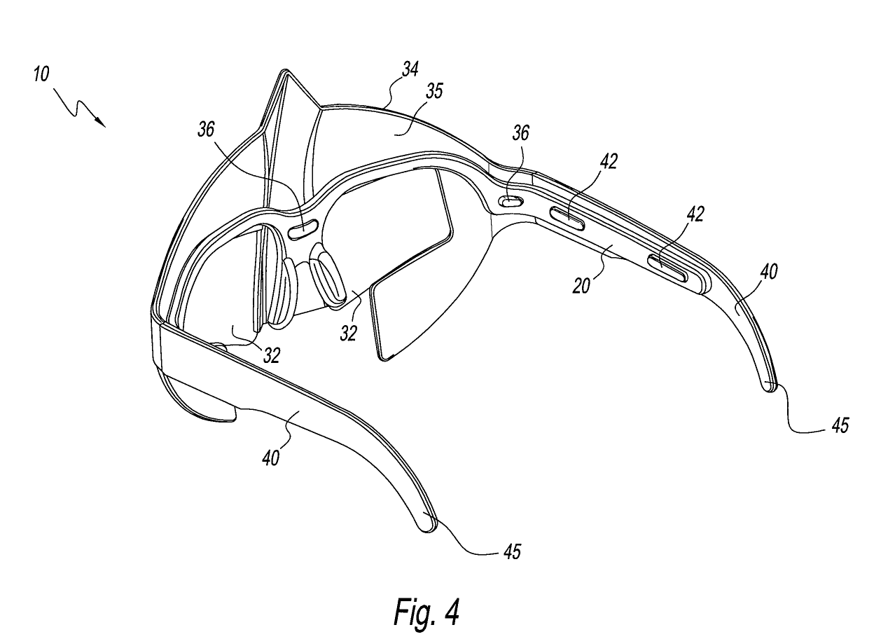

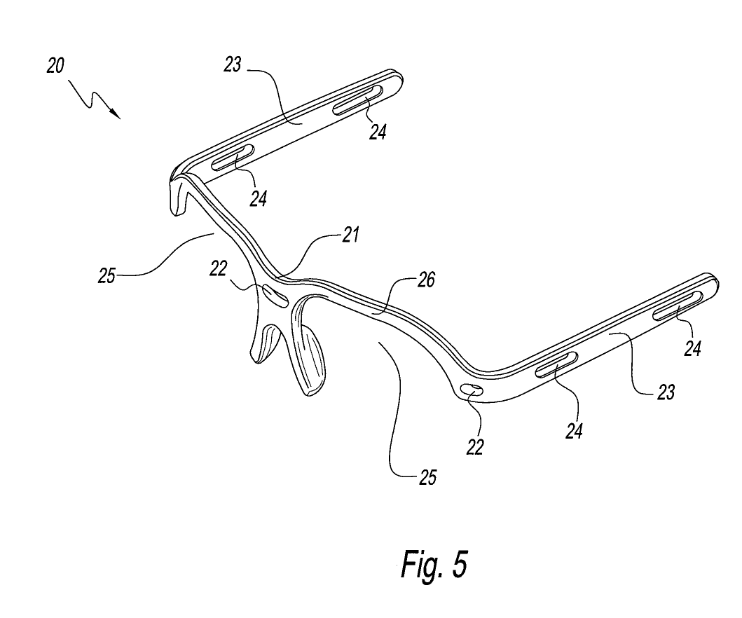

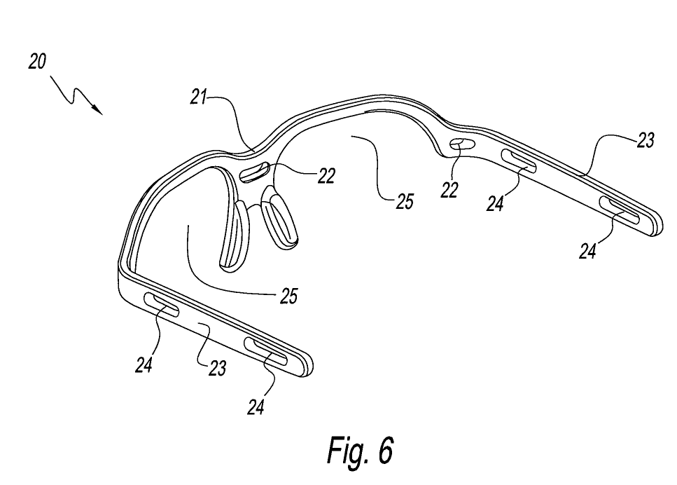

Referring to the drawings, and in particular FIGS. 1-7, a viewing device generally represented by reference numeral 10 is shown. Viewing device 10 has subframe 20, front 30, and a pair of temples 40. To assemble viewing device 10, front 30 and the pair of temples 40 are connected to subframe 20 in the manner shown.

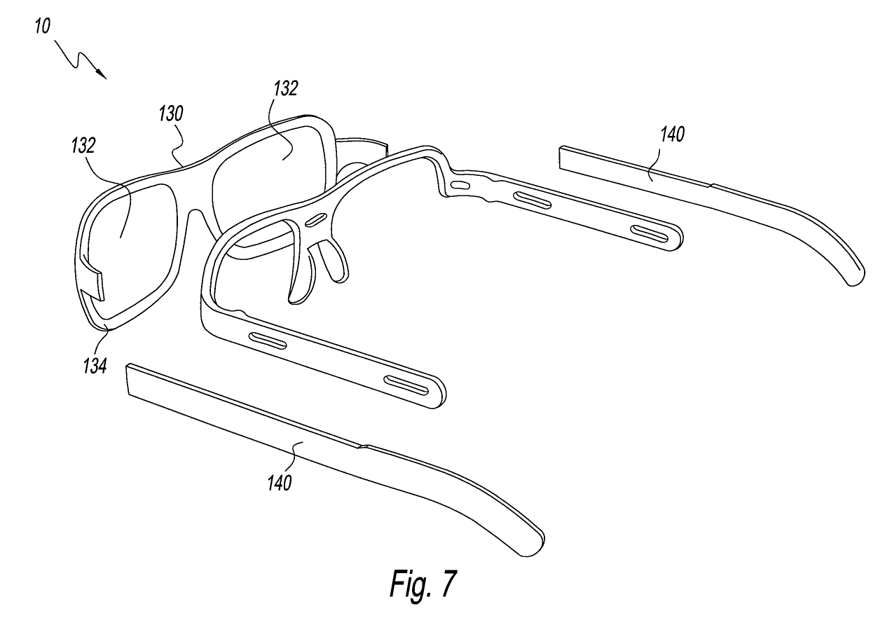

Front 30 comprises frame 34, and a pair of lenses 32 connected thereto. Frame 34 and/or lenses 32 and/or temples 40 can have various shapes, be various colors, or have marketing materials displayed thereon that are customized to a particular application, for example a scheme that incorporates aspects or themes of a movie that the user is viewing with viewing device 10. In an alternate embodiment, FIG. 7 shows front 130, lenses 132, frame 134, and temples 140, that can be used with subframe 20 in the same manner as described above with respect to front 30, lenses 32, frame 34, and temples 40, and which do not have any particular design on them.

Subframe 20 can have bridge 21, side arms 23, lens openings 25 and front face 26, so that the user looks through openings 25 when device 10 is assembled. Frame 34 has an inner surface 35, and one or more male tabs 36 thereon. Tabs 36 mate with corresponding front slots 22 (which are female) in front face 26 of subframe 20, so that front 30 is secured to subframe 20. Similarly, temples 40 have one or more male tabs 42 thereon, which mate with side slots 24 on an exterior side of side arms 23 of subframe 20, thus securing temples 40 to subframe 20. The method of connection is a friction fit, but other methods of connecting front 30 and temples 40 to subframe 20 are contemplated by the present disclosure, such as but not limited to snap fit. The number and placement of tabs 36 and tabs 42 can be varied. In one embodiment, there are three tabs 36 on inside surface 35 of front 30, two each at opposite sides of front 30, and one in the middle, and two tabs 42 on each of the temples 40. This particular embodiment allows for ease of assembly for viewing device 10, while still providing a secure connection of front 30 and temples 40 to subframe 20. The present disclosure also contemplates other ways to connect front 30 and temples 40 to subframe 20.

Viewing device 10, once assembled, appears to be a single, unitary structure. This means that the entire exterior surface of subframe 20 is covered by front 30 and temples 40. The exterior surface of subframe 20 is the one opposite the interior surface, which faces and/or contacts the user when device 10 is worn. In addition, front 30 and temples 40 appear to be one component, meaning that there are no gaps or spaces between them where subframe 20 would show through. The appearance of device 10 as a single, unitary structure has the advantage of enhancing the user's enjoyment of the application where device 10 is being employed, for example when viewing a movie.

In the embodiment shown in FIGS. 1-7, side arms 23 do not extend the entire way to a user's ears. Temples 40 can have different lengths and shapes to suit a particular user. For example, temples 40 can be longer for adults, and shorter for children. Ends 45 of temples 40 curl around the ears of a user, assisting in the securing of device 10 to the user. Thus, in this embodiment, the only point of contact between the user's ear and the viewing device 10 are through temples 40. This is yet another advantage of viewing device 10 over currently available devices, in that viewing device 10 can be easily customized for the varying physical attributes of different users.

Lenses 32 or 132 can utilize a variety of technologies to create different viewing options for the user. For example, lenses 32 and 132 can be polarized, to allow for the left and right eye of the user to see different images, in 3D applications. They can also utilize anaglyph technology, so that one of the lenses would be red, and the other cyan, a technology also utilized in 3D viewing applications. Lenses 32 and 132 can also be ophthalmic lenses that block sun glare, and only allow light to pass through in one direction, which would be useful for outdoor viewing applications, or even for general purpose outdoor use as sunglasses. Lenses 32 and 132 can also be clear or tinted prescription lenses. They can also be designed for use in toys or costumes, or for New Years Eve celebration glasses. The present disclosure also contemplates that lenses 32 and 132 can use any optical technologies, or have any number of decorative designs, in addition to those specifically described above.

Lenses 32 and 132 can be permanently connected to frames 34 and 134 of fronts 30 and 130, respectively. Alternatively, lenses 32 and 132 can be removably connected to frames 34 and 134, respectively, so that different lenses can be swapped out, depending on the desired use, while still using the same frame.

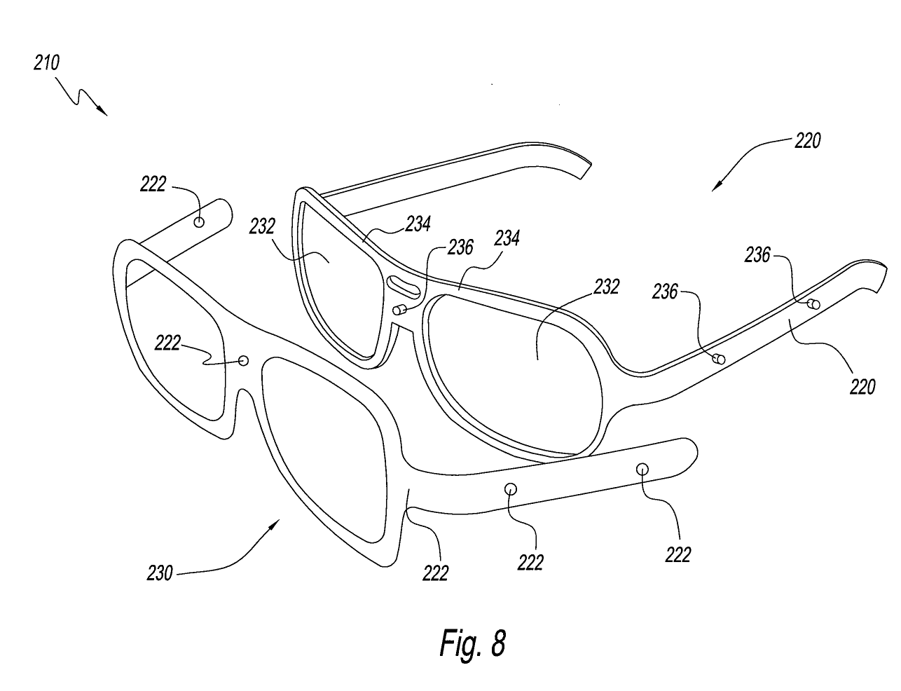

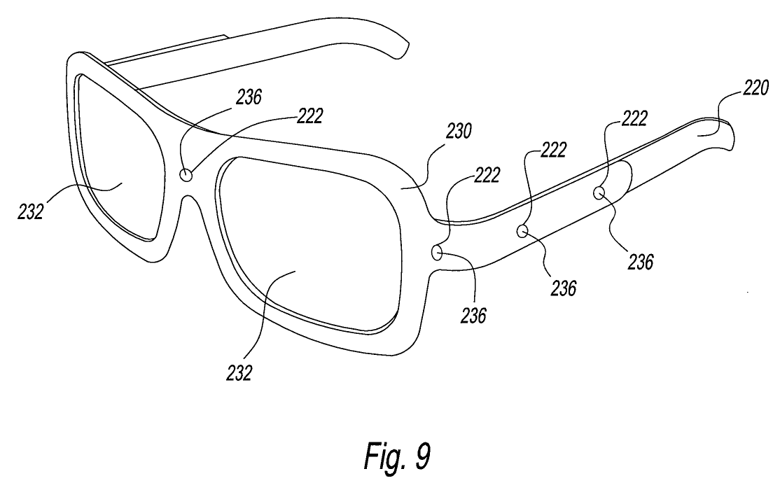

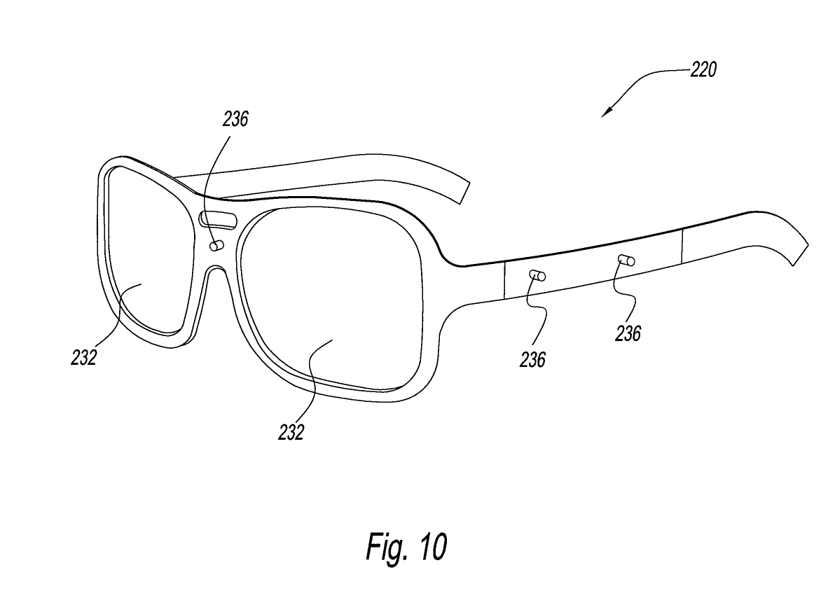

Referring to FIGS. 8-10, another embodiment of the viewing device of the present disclosure is shown, and referenced by numeral 210. Viewing device 210 has frame 220, lenses 232, and visor 230. Compared to frame 20 of viewing device 10, frame 220 has a pair of receptacles 234 that fully surround lenses 232, so that lenses 232 are connected directly to frame 220. Viewing device 210 is advantageous in that it is lower cost than viewing device 10, but still provides for customization, as discussed below.

To assemble viewing device 210, visor 230 is placed over frame 220. Frame 220 has a plurality of securing tabs 236 on a front and side surfaces thereof, to mate with corresponding holes 222 in visor 230, to hold visor 230 in place. The number and location of securing tabs 236 and holes 222 can vary. In the shown embodiment, there are three securing tabs 236 on each side of frame 220, and one in the middle of the front surface of frame 220, which provides for an easy and stable assembly of viewing device 210. Visor 230 can be customized with various shapes, color schemes, and marketing materials, which, for example, can be coordinated with the movie that the user may be watching.

Similarly to lenses 32 and 132 of viewing device 10, lenses 232 can be different types, depending on the image to be viewed, such as polarized lenses, anaglyph lenses, ophthalmic lenses, or any other type. Lenses 232 can be permanently connected to frame 220, or can be removable, so that they can be changed out for a particular use.

With either viewing device 10 or viewing device 210, the materials used for the various components can be any of a variety of plastic, paper or metal substances.

As shown in the Figures, viewing devices 10 and 210 can be customized for use in a variety of different applications, with limitless designs, which enhance the viewer's enjoyment of the viewing experience. Viewing devices 10 and 210 are very easily assembled, and save costs when compared to currently available devices, since subframe 20 and frame 220 can be reused for any number of applications.

The present disclosure further contemplates various methods for marketing and selling the viewing devices of the present disclosure. For example, when the viewing devices are used to watch movies in movie theaters, the movie studio producing the movie may sell the viewing devices to the consumer as they buy the ticket. After viewing the movie, the user can recycle the viewing devices at the movie theater, or keep them as collectibles. Alternatively, the movie studio may partner with a sponsor, who would sell the viewing devices with one of the sponsor's products. The user would then show the devices at the movie theater, and receive a complimentary or reduced-fare movie ticket. In another method, a retailer may sell the viewing devices, with or without different frames, lenses, or visors. The user can then use the glasses at the movie theater, at home when watching a movie or playing a video game, or for other applications such as the outdoor viewing discussed above, and customize their viewing devices for whatever use they desire at a particular time. The user can also collect different fronts and visors, and use them all with the subframes or frames that they have purchased.

While the instant disclosure has been described with reference to one or more to particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A viewing device for a user, comprising:
a subframe having a front face, two side arms, and two lens openings;
a front removably connected to said front face of said subframe; and
two temples, wherein each of said two temples are removably connected to one of said side arms,
wherein the user wears the viewing device to look through said lens openings and said front, when the viewing device is in use.

2. The viewing device of claim 1, wherein said front has a pair of lenses connected thereto, and wherein each of said pair of lenses corresponds to one of said pair of lens openings, when said front is connected to said subframe.

3. The viewing device of claim 2, wherein said lenses are selected from the group consisting of polarized lenses, anaglyph lenses, and ophthalmic lenses.

4. The viewing device of claim 3, wherein said lenses are ophthalmic.

5. The viewing device of claim 3, wherein said lenses are polarized.

6. The viewing device of claim 5, wherein each of said pair of lenses projects a different image to the user than the other.

7. The viewing device of claim 1, wherein each of said two temples has a curved portion at an end of said temple, with said curved portion adapted to fit behind the ears of the user.

8. The viewing device of claim 7, wherein each of said two side arms do not extend to the user's ear, so that said two temples are the only point of contact between the user's ear and the viewing device.

9. The viewing device of claim 1, wherein said front has a tab on an interior surface thereon, and wherein said front face of said subframe has a slot thereon.

10. The viewing device of claim 9, wherein said front is connected to said front face of said subframe by mating said tab with said slot.

11. The viewing device of claim 1, wherein each of said two temples has a side tab on an interior surface thereon, and each of said two side arms of said subframe have a side slot thereon.

12. The viewing device of claim 11, wherein each of said two temples is connected to one of said two side arms by mating said side tab with said side slot.

13. The viewing device of claim 1, wherein said subframe has an exterior surface that is completely covered by said front and said two temples, so that said front and said two temples together appear to be a single, unitary structure.

14. The viewing device of claim 1, wherein at least one of said front and said two temples has a logo thereon.

15. The viewing device of claim 1, wherein at least one of said front and said two temples has a decorative design.

16. The viewing device of claim 1, further comprising a pair of lenses permanently connected to said subframe in said lens openings.
